(19) United States
(12) Patent Application Publication
(10) Pub. No.: US 2026/0252134 A1
(43) Pub. Date: Aug. 27, 2026

(54) LDO VOLTAGE GENERATOR WITH SMOOTH SWITCH-OVER MANAGEMENT

(71) Applicant: STMicroelectronics International N.V., Geneva (CH)

(72) Inventors: Federico FARY, Aosta (IT); Sandro ROSSI, Pavia (IT)

(73) Assignee: STMicroelectronics International N.V., Geneva (CH)

(21) Appl. No.: 19/062,292

(22) Filed: Feb. 25, 2025

(51) Int. Cl. G05F 1/575; G05F 1/569; H02M 3/158

(52) U.S. Cl. CPC G05F 1/575; G05F 1/569; H02M 3/158

(57) ABSTRACT

Disclosed herein is a dual low-dropout (LDO) regulator system including two LDO regulators sharing a single operational amplifier, configured for switchover operation. The first LDO regulator is supplied from a high-voltage input, while the second is supplied from from a regulated output voltage. Both regulators remain partially active during operation, with the second LDO regulator taking over a majority of the load current when the regulated output voltage reaches sufficient levels. This prevents voltage dips and oscillations commonly seen in traditional two-LDO systems during switchover.

### TECHNICAL FIELD

This disclosure relates to the field of voltage regulators and, in particular, to a voltage regulator design utilizing dual low drop-out (LDO) regulator loops that share a single amplifier.

### BACKGROUND

Power management in DC-DC buck converters involves two regulators working together, namely a main buck converter that steps down an input voltage VIN to an output voltage VOUT, and an internal low drop-out (LDO) regulator that further reduces the output voltage VOUT to a regulator voltage VCC for use in powering the control circuitry of the regulator. Conventionally, this LDO regulator is powered directly from the input voltage VIN, resulting in power loss. A more efficient technique called switchover instead powers the LDO regulator from the output voltage VOUT once that regulated output voltage VOUT is available.

The switchover approach is particularly useful in high step-down applications (e.g., 48 V to 5 V) where the ratio of VOUT to VIN is large, as powering the LDO regulator from VOUT rather than VIN reduces power dissipation. However, this results in a challenge at startup – since VOUT does not exist until the buck converter begins operating, the LDO regulator must initially draw from VIN to generate the voltage VCC needed for the controller to start. Once VOUT is generated at its regulated level, a handoff circuit switches the input of the LDO regulator from VIN to VOUT.

The internal circuitry of the LDO regulator is configured to reference VCC during normal operation. This self-referencing works after VOUT reaches sufficient levels. Thus, during startup, the internal circuitry of the LDO regulator must temporarily operate from VIN until VOUT is established. The switchover technique described manages this transition between supply paths using switches and control logic that prevent unwanted current paths between VIN and VOUT.

Current implementations typically use either dual LDO regulators (one powered from VIN, another from VOUT) or a single LDO regulator with selection circuitry to switch between VIN and VOUT. Both approaches have tradeoffs in silicon area, efficiency, and complexity, driving continued innovation in this field.

Referring to FIG. 1, the known dual LDO regulator 5 approach to implement switchover is now described. In this approach, a first LDO regulator 6, is supplied from the high‐voltage input VIN and its output provides the internal supply voltage VCC. A second LDO regulator 7, is supplied instead from the regulated output node VOUT.

A switch SW1 is coupled between VCC and the input of LDO regulator 7 so that one or both of the LDO regulators 6 or 7 may be enabled or disabled as needed. Complementary control signals DISABLE_LDO_VIN and ENABLE_LDO_VOUT selectively turn each LDO regulator 6 or 7 on or off. This allows internal circuitry to be powered from VIN during startup, via LDO regulator 6, and then switched to VOUT once the output has reached a sufficiently high voltage to supply VCC.

Turning to FIG. 2, the known single LDO regulator 5’ approach is shown. Here, LDO regulator 6 alone provides the internal supply voltage VCC but is designed to accept either VIN or VOUT as its input. Two switches, SW2 and SW3, control whether the LDO regulator receives power from the high‐voltage supply VIN or from the regulated output VOUT. To prevent shoot‐through current that could otherwise flow directly between VIN and VOUT, a dedicated disoverlap control circuit 8 suitably and properly controls the operation of SW2 and SW3. The control signal SWO_ENABLE is used to command or disable the switch‐over function. This ensures that SW2 and SW3 do not both turn on simultaneously, thereby avoiding direct conduction between VIN and VOUT.

While the dual LDO regulator circuit of FIG. 1 and the single LDO regulator circuit of FIG. 2 both address the need for reducing internal power dissipation, each has limitations. The dual LDO regulator approach of FIG. 1 consumes excess die area and can introduce output instabilities during the handover event. The single LDO regulator approach of FIG. 2 requires that the LDO regulator and its switches SW2, SW3 be rated for high voltage, increasing size and driving‐circuit complexity. Additionally, these switches must be large to reduce their on‐resistance, yet driven with the proper disoverlap timing to avoid cross‐conduction.

Accordingly, further development into circuits facilitating switchover remains necessary.

### SUMMARY

A device is for providing a regulated supply with switchover operation between a first low-dropout regulator and a second low-dropout regulator. The first low-dropout regulator is coupled to a high-voltage input line and has a first set of p-channel transistors arranged in a first current mirror. The second low-dropout regulator is coupled to a regulated output line and has a second set of p-channel transistors arranged in a second current mirror. A single operational amplifier drives at least one n-channel transistor in each of the first and second low-dropout regulators, with the single operational amplifier being powered by an internally regulated supply line. A switchover control circuit compares a reference voltage with a feedback voltage derived from the regulated output line, and selectively enables the second low-dropout regulator while maintaining partial conduction in the first low-dropout regulator.

The first set of p-channel transistors may include a diode-connected transistor that establishes a reference current mirrored into the internally regulated supply line.

The switchover control circuit may have a comparator and switching elements that open and close conduction paths associated with the second low-dropout regulator, preventing reverse flow from the internally regulated supply line toward the regulated output line when the regulated output line is below a given threshold.

The single operational amplifier may receive a reference voltage at a non-inverting input and a feedback voltage at an inverting input, thereby regulating the internally regulated supply line through at least one resistor to ground.

The device may have a startup bias circuit that receives a bias current from a current source and initially charges the internally regulated supply line before the single operational amplifier becomes fully active.

The second low-dropout regulator may include an output stage sized to provide a majority of load current once the regulated output line is sufficiently higher than the internally regulated supply line, while the first low-dropout regulator conducts a minority of load current from the high-voltage input line.

The first low-dropout regulator may have an n-channel transistor driven by the single operational amplifier, the n-channel transistor being connected to the first set of p-channel transistors in a configuration that regulates conduction from the high-voltage input line.

The second low-dropout regulator may have an n-channel transistor whose gate is selectively driven by the single operational amplifier through the switchover control circuit, enabling the second low-dropout regulator to supply the internally regulated supply line from the regulated output line during switchover.

The switchover control circuit may have a logic gate that combines an output from the comparator and a switchover state signal, generating a switchover command that determines whether the second low-dropout regulator is enabled or disabled.

The feedback voltage derived from the regulated output line may be generated by a resistor divider connected between the regulated output line and ground.

The startup bias circuit may have high-voltage n-channel transistors configured to conduct from the high-voltage input line to the internally regulated supply line until the single operational amplifier can operate reliably.

The single operational amplifier may be implemented with transistors rated for voltages lower than that of the high-voltage input line.

The switchover control circuit may include hysteresis to avoid repeated toggling of the conduction paths for the second low-dropout regulator when the regulated output line voltage is near the internally regulated supply line voltage.

### BRIEF DESCRIPTION OF THE DRAWINGS

FIG. 1 is block diagram of a prior art dual-LDO regulator system utilizing switchover.

FIG. 2 is a block diagram of a single LDO regulator system utilizing switchover.

FIG. 3 is a schematic diagram of a dual-LDO regulator voltage converter system.

FIG. 4 is a graph illustrating how current from VIN and current from VOUT transition as VOUT approaches VCC.

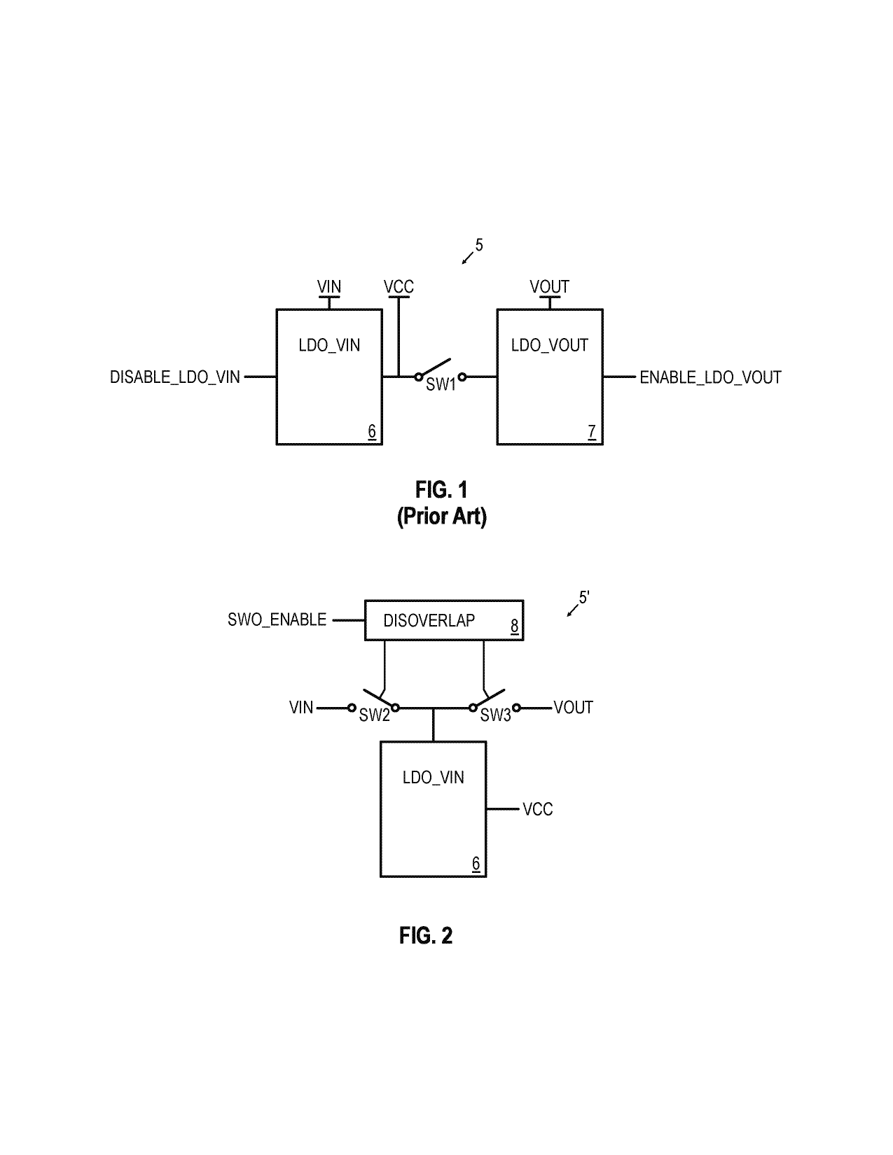

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

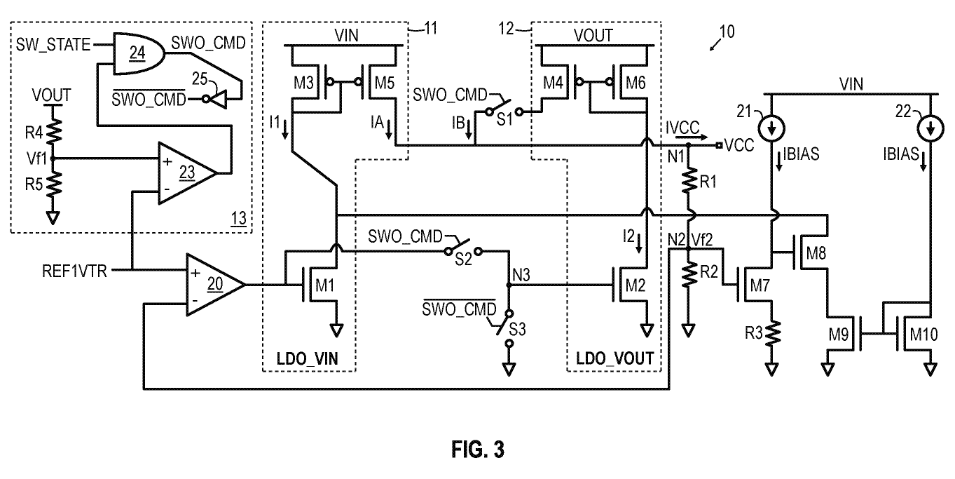

Now described with reference to FIG. 3 is a dual-LDO system 10 capable of switchover operation, with the two LDO regulators 11 and 12 in the system 10 sharing a single operational amplifier 20.

The first LDO regulator 11 is supplied from the high-voltage input VIN and includes p-channel transistors M3 and M5 in a current mirror configuration. Specifically, the sources of M3 and M5 are coupled to VIN, the gates of M3 and M5 are connected to one another as well as to the drain of M3, and the drain of M5 is connected to node N1. The first LDO regulator 11 further includes n-channel transistor M1 having its drain connected to the drain of p-channel transistor M3, its source coupled to ground, and its gate connected to receive the output of operational amplifier 20.

The second LDO regulator 12 is supplied from the regulated output voltage VOUT and includes p-channel transistors M4 and M6 in a current mirror configuration, with the sources of M4 and M6 being coupled to VOUT, the gates of M4 and M6 being connected to one another as well as to the drain of M6, and the drain of M4 being coupled through switch S1 to node N1. The second LDO regulator 12 further includes n-channel transistor M2 having its drain connected to the drain of p-channel transistor M6, its source coupled to ground, and its gate connected to node N3.

Switch S2 is connected between the output of operational amplifier 20 and node N3, and switch S3 is coupled between node N3 and ground. Switches S1, S2, and S3 are controlled by switchover control signal SWO_CMD, with switches S1 and S2 closing in response to assertion of SWO_CMD and switch S3 closing in response to assertion of an inverse of SWO_CMD (e.g., via inverter 25).

Switchover control circuit 13 generates SWO_CMD. It includes comparator 23 that compares a feedback voltage Vf1 (generated at a tap between series-connected resistors R4 and R5 from VOUT to ground) to a reference voltage REF1VTR. The output of comparator 23 goes to a first input of OR gate 24, whose second input is coupled to receive a SW_STATE signal. SWO_CMD is generated at the output of OR gate 24, and its inverse is generated by inverter 25.

The non-inverting input of operational amplifier 20 is coupled to receive the reference voltage REF1VTR, and the inverting input of amplifier 20 is connected to node N2 to receive feedback voltage Vf2. Resistor R1 is connected between nodes N1 and N2 (so that the regulated voltage VCC appears at node N1, with feedback taken through resistor R1), and resistor R2 is connected between node N2 and ground. Hence, the feedback voltage Vf2 is generated at node N2 and supply voltage VCC is generated at node N1.

N-channel transistor M7 has its gate connected to node N2 (to receive feedback voltage Vf2), its source coupled to ground through resistor R3, and its drain coupled to receive a bias current IBIAS from current source 21. N-channel transistor M8 has its gate connected to the drain of n-channel transistor M7, its drain connected to the drains of p-channel transistor M3 and n-channel transistor M1, and its source connected to the drain of n-channel transistor M9. N-channel transistor M9 has its source coupled to ground and its gate tied to the gate/drain of n-channel transistor M10. The drain of transistor M10 is coupled to a second bias current IBIAS from current source 22, and its source is at ground.

The amplifier 20 is powered from supply voltage VCC (node N1) and can be built from lower-voltage components because it does not need to tolerate the full input voltage VIN. N-channel transistors M7, M8, M9, and M10 (with transistors M7 and M8 being high-voltage capable devices) form part of the startup and bias circuitry. Current sources 21 and 22 provide the bias currents IBIAS.

In LDO regulator 11, p-channel transistors M3 and M5 share a common gate, and the diode-connected transistor M3 (gate and drain tied) establishes a reference current that transistor M5 mirrors into node N1, thereby charging the external capacitor on the voltage VCC. When voltage VCC is sufficiently high for amplifier 20 to operate, the amplifier drives transistor M1, thereby regulating the load on voltage VCC.

During startup, the bias current IBIAS flows into transistors M7 and M8, activating transistor M3 in its diode configuration and charging voltage VCC even before amplifier 20 is active. As soon as voltage VCC exceeds amplifier 20’s required minimum supply, transistor M7 turns off via internal control signals, shutting down the startup path and preventing unnecessary power consumption. Comparator hysteresis helps avoid repeated on/off toggling around this threshold.

Once LDO regulator 11 actively regulates voltage VCC, the second LDO 12 remains largely off unless its supply voltage VOUT is both above the reference voltage REF1VTR and above voltage VCC (per comparator 23’s decision). This ensures that LDO regulator 12 only comes online when it can drive voltage VCC from voltage VOUT. When these conditions are satisfied, switchover control circuit 13 asserts signal SWO_CMD, closing switches S1 and S2 to connect transistors M4/M6 and transistor M2 to the shared amplifier 20 and node N1. Meanwhile, switch S3 opens to release node N3 from ground, allowing transistor M2 to conduct.

In this arrangement, transistors M4 and M6 are typically sized with higher transconductance than transistors M3 and M5, so once voltage VOUT is sufficiently higher than voltage VCC, most of the current drawn by the voltage VCC load flows through LDO regulator 12. However, LDO regulator 11 never fully switches off. Because transistor M5 is smaller, and transistor M1 is also sized smaller relative to transistor M2, the first LDO regulator remains weakly on, supplying minimal current from voltage VIN. This low-current state of LDO regulator 11 ensures that if voltage VOUT dips or if a load transient occurs, transistor M5 can quickly respond from voltage VIN, helping avoid undershoot, oscillations, or excessive transient delays.

During any interval where VOUT ≈ VCC, LDO regulator 12 may be in drop-out, but the fact that LDO regulator 11 is never off helps maintain a stable voltage VCC and filter out load or noise variations. The design trade-off is a slight increase in power consumption when both LDO regulators overlap, because some current continues to flow from voltage VIN.

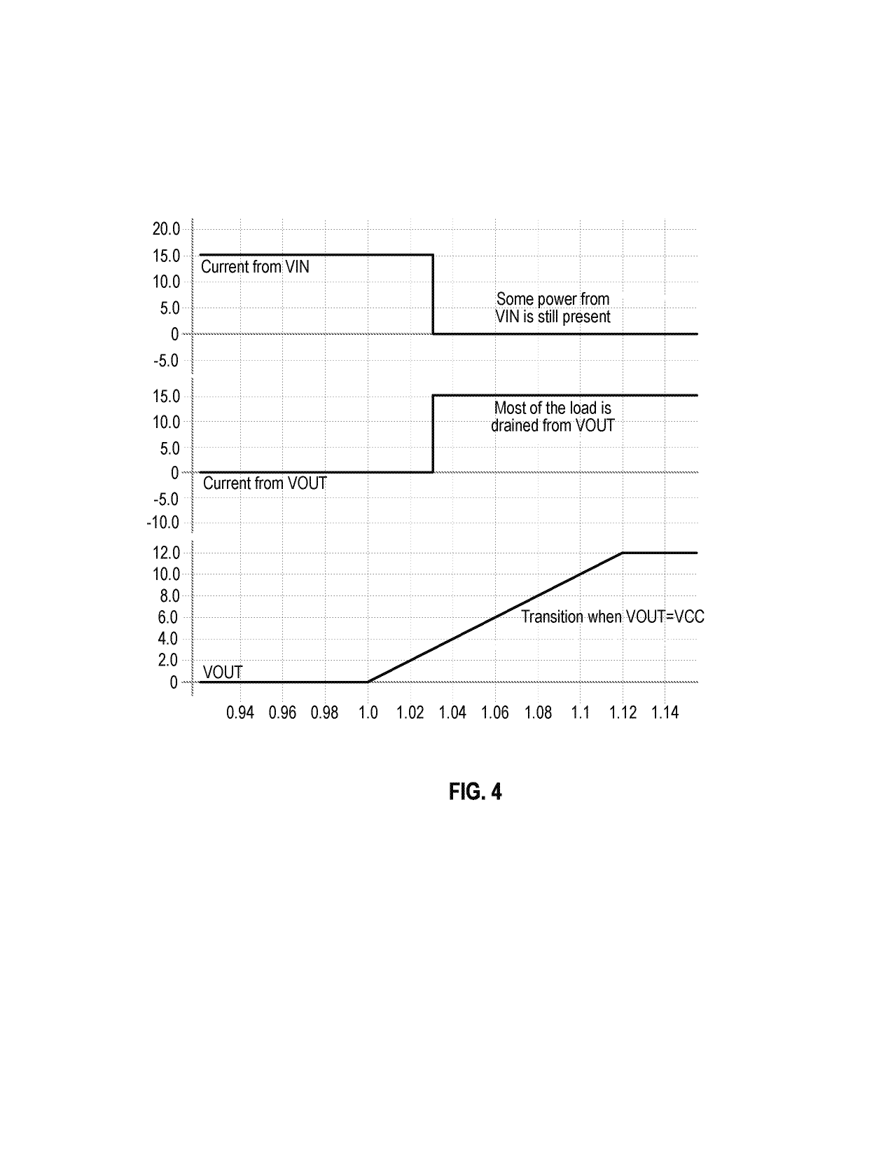

Referring to FIG. 4, the graph shows a representative example of how the current from voltage VIN (top trace) and the current from voltage VOUT (middle trace) transition as voltage VOUT ramps up to approximately voltage VCC (bottom trace). In particular, when voltage VOUT initially is below voltage VCC, LDO regulator 11 supplies most of the current from voltage VIN, but as voltage VOUT rises, LDO regulator 12 takes over the bulk of the load. Even after this switchover, a small current from voltage VIN remains, preventing dips on voltage VCC if voltage VOUT suddenly droops. The figure thus illustrates how most of the load transitions smoothly from voltage VIN to voltage VOUT, reducing the chance of overshoot or undershoot on voltage VCC.

To prevent backflow from voltage VCC to voltage VOUT (in case voltage VOUT falls below voltage VCC), the switchover control circuit 13 de-asserts signal SWO_CMD upon detecting that voltage VOUT is either less than the reference or less than voltage VCC. As a result, switches S1 and S2 open, switch S3 closes (tying node N3 to ground), and the second LDO regulator’s gate driver is switched off, eliminating reverse conduction. Again, hysteresis is important to avoid chatter or repeated switch toggling.

This design saves area and ensures reliable operation by merging what would otherwise be two separate LDO regulator loops into a single feedback amplifier, which occupies less silicon than two distinct amplifiers. This allows the single amplifier 20 to be implemented using lower‐voltage transistors, without the overhead of high‐voltage design rules, even in applications where voltage VIN might exceed 100 V. The dual‐LDO regulator setup further prevents dips or oscillations on voltage VCC that can arise in traditional two‐LDO regulator schemes when one regulator is fully shut off and must be restarted if the other supply droops. By permitting a smooth partial overlap of the two LDO regulators, the transition from powering voltage VCC via voltage VIN to powering it via voltage VOUT proceeds gradually, minimizing overshoot or undershoot. Furthermore, although the described embodiment uses two‐stage LDO regulators, the principle can be extended to any LDO regulator topology, can be adapted to share not only the error amplifier but also gate‐driver buffers, and can scale to more than two supply domains by including additional output stages supplied from each new input. Transistor sizing is used to balance how much of the load current is drawn from each supply, which is particularly advantageous in power‐management ICs that generate multiple regulated outputs. Compared to a conventional two‐LDO regulator arrangement, the design here requires fewer total components, utilizes only a single amplifier for both regulators, and avoids transients associated with fully disabling one LDO regulator.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A device for providing a regulated supply with switchover operation between a first low-dropout regulator and a second low-dropout regulator, the device comprising:
the first low-dropout regulator coupled to a high-voltage input line and including a first set of p-channel transistors arranged in a first current mirror;
the second low-dropout regulator coupled to a regulated output line and including a second set of p-channel transistors arranged in a second current mirror;
a single operational amplifier configured to drive at least one n-channel transistor in each of the first and second low-dropout regulators, the single operational amplifier being powered by an internally regulated supply line; and
a switchover control circuit configured to compare a reference voltage with a feedback voltage derived from the regulated output line, and to selectively enable the second low-dropout regulator while maintaining partial conduction in the first low-dropout regulator.

2. The device of claim 1, wherein the first set of p-channel transistors includes a diode‐connected transistor that establishes a reference current mirrored into the internally regulated supply line.

3. The device of claim 1, wherein the switchover control circuit comprises a comparator and switching elements that open and close conduction paths associated with the second low-dropout regulator, preventing reverse flow from the internally regulated supply line toward the regulated output line when the regulated output line is below a given threshold.

4. The device of claim 1, wherein the single operational amplifier receives a reference voltage at a non-inverting input and a feedback voltage at an inverting input, thereby regulating the internally regulated supply line through at least one resistor to ground.

5. The device of claim 1, further comprising a startup bias circuit that receives a bias current from a current source and initially charges the internally regulated supply line before the single operational amplifier becomes fully active.

6. The device of claim 1, wherein the second low-dropout regulator includes an output stage sized to provide a majority of load current once the regulated output line is sufficiently higher than the internally regulated supply line, while the first low-dropout regulator conducts a minority of load current from the high‐voltage input line.

7. The device of claim 1, wherein the first low-dropout regulator further includes an n-channel transistor driven by the single operational amplifier, the n-channel transistor being connected to the first set of p-channel transistors in a configuration that regulates conduction from the high-voltage input line.

8. The device of claim 1, wherein the second low-dropout regulator further includes an n-channel transistor whose gate is selectively driven by the single operational amplifier through the switchover control circuit, enabling the second low-dropout regulator to supply the internally regulated supply line from the regulated output line during switchover.

9. The device of claim 1, wherein the switchover control circuit further comprises a logic gate that combines an output from the comparator and a switchover state signal, generating a switchover command that determines whether the second low-dropout regulator is enabled or disabled.

10. The device of claim 1, wherein the feedback voltage derived from the regulated output line is generating by a resistor divider connected between the regulated output line and ground.

11. The device of claim 1, wherein the startup bias circuit comprises high-voltage n-channel transistors configured to conduct from the high-voltage input line to the internally regulated supply line until the single operational amplifier can operate reliably.

12. The device of claim 1, wherein the single operational amplifier is implemented with transistors rated for voltages lower than that of the high-voltage input line.

13. The device of claim 1, wherein the switchover control circuit includes hysteresis to avoid repeated toggling of the conduction paths for the second low-dropout regulator when the regulated output line voltage is near the internally regulated supply line voltage.

14. A method of providing switchover operation between low-dropout regulators, the method comprising:
generating an internally regulated supply voltage using a first low-dropout regulator coupled to a high-voltage input line;
comparing a feedback voltage derived from a regulated output line to a reference voltage;
selectively enabling a second low-dropout regulator coupled to the regulated output line based on the comparison while maintaining partial conduction in the first low-dropout regulator; and
controlling both the first and second low-dropout regulators using a single operational amplifier powered by the internally regulated supply voltage.

15. The method of claim 14, further comprising:
establishing a reference current using a diode-connected p-channel transistor in the first low-dropout regulator; and
mirroring the reference current to charge the internally regulated supply voltage through a second p-channel transistor.

16. The method of claim 14, further comprising:
providing a startup bias current to charge the internally regulated supply voltage before the single operational amplifier becomes active; and
disabling the startup bias current when the internally regulated supply voltage exceeds a minimum operating threshold for the single operational amplifier.

17. The method of claim 14, wherein selectively enabling the second low-dropout regulator comprises:
closing a first switch to connect an output stage of the second low-dropout regulator to the internally regulated supply voltage;
closing a second switch to couple the single operational amplifier to a control terminal of a transistor in the second low-dropout regulator; and
opening a third switch to release the control terminal from ground.

18. The method of claim 14, further comprising:
detecting when the regulated output line voltage falls below the internally regulated supply voltage; and
disabling the second low-dropout regulator to prevent reverse current flow from the internally regulated supply voltage to the regulated output line.

19. The method of claim 14, wherein maintaining partial conduction in the first low-dropout regulator comprises:
sizing transistors in the second low-dropout regulator to conduct a majority of load current when enabled; and
sizing transistors in the first low-dropout regulator to maintain a minimal current flow from the high-voltage input line.
